(19) United States
(12) Patent Application Publication
(10) Pub. No.: US 2021/0313612 A1
(43) Pub. Date: Oct. 7, 2021

(54) Battery Including Bipolar Cells that have a Solid Polymer Peripheral Edge Insulator

(71) Applicant: Robert Bosch GmbH, Stuttgart (DE)

(72) Inventors: Ralf Angerbauer, Moeglingen (DE); Bernd Schumann, Rutesheim (DE); Florian Schmid, Korntal (DE); Joerg Thielen, Briedel (DE); Christian Diessner, Muehlacker-Muehlhausen (DE); Mark Kotik, Rochester Hills, MI (US); David Naughton, Oxford, MI (US); Jerome Homann, Renningen (DE); Anne Serout, Stuttgart (DE); Laura Bauer, Altendorf (DE); Steve Scott, Fairborn, OH (US); Dan Schneider, Orion, MI (US); Gary Mosley, Cincinnati, OH (US)

(21) Appl. No.: 17/054,912

(22) PCT Filed: May 17, 2019
(86) PCT No.: PCT/EP2019/062795

§ 371 Date: Nov. 12, 2020

Related U.S. Application Data
(60) Provisional application No. 62/677,979, filed on May 30, 2018.

(51) Int. Cl. H01M 10/04; H01M 10/0565; H01M 10/0562

(52) U.S. Cl. CPC H01M 10/0418; H01M 10/0562; H01M 10/0565

(57) ABSTRACT

A battery includes a stacked arrangement of electrochemical cells. Each electrochemical cell is free of a cell housing and includes a bipolar plate having a substrate, a first active material layer formed on a first surface of the substrate, and a second active material layer formed on a second surface of the substrate. Each cell includes a solid electrolyte layer that encapsulates at least one of the active material layers, and electrically insulates a given cell of the cell stack from an adjacent cell of the cell stack including along a periphery of the cells.

### BACKGROUND

Batteries provide power for various technologies ranging from portable electronics to renewable power systems and environmentally friendly vehicles. For example, hybrid electric vehicles (HEV) use a battery and an electric motor in conjunction with a combustion engine to increase fuel efficiency. Electric vehicles (EV) are entirely powered by an electric motor that is in turn powered by one or more batteries. The batteries may include several electrochemical cells that are arranged in two or three dimensional arrays and are electrically connected in series or in parallel. In a series connection, the positive and the negative pole of each of two or more cells are electrically connected with each other and the voltages of the cells are added to give a battery of cells with a larger voltage. For example, if n cells are electrically connected in series, the battery voltage is the voltage of a single cell multiplied by n, where n is a positive integer.

Individual cells are typically enclosed in a gas-impermeable housing. Often, the housing may be electrically connected to one pole of the cell. In applications where the cells are electrically connected to each other in series, for example by providing a connection between a positive pole of one cell with the negative pole of the adjacent cell, the cell voltages are additive and the housings have to be insulated from each other to prevent a short circuit. However, within the battery, the space used to accommodate, and materials used by, the cell housings and the corresponding insulating structures reduce battery efficiency and increase manufacturing complexity and costs.

### SUMMARY

In some aspects, a battery includes a stacked arrangement of electrochemical cells. Each electrochemical cell includes a bipolar plate and a solid electrolyte layer. The bipolar plate includes a substrate, a first active material layer formed on a first surface of the substrate, and a second active material layer formed on a second surface of the substrate. The second surface is opposed to the first surface. The first active material layer has a first active material layer peripheral edge that is spaced apart from, and disposed closer to a center of the substrate than, a substrate peripheral edge. The second active material layer is formed of a different material than the material used to form the first active material layer. The second active material layer has a second active material layer peripheral edge that is spaced apart from the substrate peripheral edge. The solid electrolyte layer is ionically conductive and electrically insulative. The solid electrolyte layer includes a separating portion and an edge insulating portion that is contiguous with the separating portion. The separating portion is disposed between, and facilitates ion conduction between, the first active material layer of a given cell and the second active material layer of an adjacent cell in the cell stacking direction. The edge insulating portion is disposed between the first surface of the given cell and the second active material layer of the adjacent cell in the cell stacking direction. The separating portion and the edge insulating portion cooperate to encapsulate the first active material layer.

In some embodiments, other than the solid electrolyte layer, the stacked arrangement of electrochemical cells is free of an electrically insulating structure between each pair of adjacent bipolar plates.

In some embodiments, the edge insulating portion is disposed further from the center of the substrate than the separating portion, and the edge insulating portion surrounds a periphery of the separating portion.

In some embodiments, regardless of the charge state of the cells, the edge insulating portion has a thickness that is greater than the thickness of the separating portion and that is less than a sum of the thicknesses of the first active material layer, the separating portion and the second active material layer, where the thickness corresponds to a dimension in a direction parallel to a stacking direction of the cells.

In some embodiments, the separating portion is formed of a material and includes ionically conductive salt, and the edge insulating portion is formed of the material and is free of ionically conductive salt.

In some embodiments, the first active material layer peripheral edge is disposed closer to the center of the substrate than both the substrate peripheral edge and the second active material layer peripheral edge.

In some embodiments, a peripheral edge of the solid electrolyte layer is closer to the center of the substrate than the second active material layer peripheral edge, and the peripheral edge of the solid electrolyte layer is further from the center of the substrate than the first active material layer peripheral edge.

In some embodiments, a peripheral edge of the solid electrolyte layer is further the center of the substrate than the second active material layer peripheral edge and the first active material layer peripheral edge.

In some embodiments, the edge insulating portion is secured to the first surface.

In some embodiments, the edge insulating portion surrounds the separating portion and has the shape of a frame when viewed in a direction parallel to a stacking direction of the cells.

In some embodiments, the battery includes a battery housing that encloses the stacked arrangement of cells, the battery housing configured to prevent contaminants from entering an interior space of the battery housing.

In some embodiments, the battery housing is formed of a flexible material that is a laminate of a metal foil that is sandwiched between polymer layers.

In some embodiments, the first active material layer cooperates with the first surface to provide a cell cathode, and the second active material layer cooperates with the second surface to provide a cell anode.

In some embodiments, the solid electrolyte layer is formed of a polymer.

In some embodiments, the solid electrolyte layer is formed of a ceramic.

In some embodiments, the solid electrolyte layer is formed of composite of a polymer and a ceramic.

In some embodiments, the solid electrolyte layer is secured to the given cell and free to move relative to the adjacent cell, or is secured to the adjacent cell and is free to move relative to the given cell.

In some aspects, a battery includes a stacked arrangement of electrochemical cells. Each electrochemical cell includes a bipolar plate, a solid electrolyte layer and an edge insulating device that is a solid electrolyte material. The bipolar plate includes a substrate, a first active material layer formed on a first surface of the substrate, and a second active material layer formed on a second surface of the substrate. The second surface is opposed to the first surface. The first active material layer has a first active material layer peripheral edge that is spaced apart from, and disposed closer to a center of the substrate than, a substrate peripheral edge. The second active material layer is formed of a different material than the material used to form the first active material layer. The second active material layer has a second active material layer peripheral edge that is spaced apart from the substrate peripheral edge. The solid electrolyte layer is formed of a solid electrolyte material and is disposed between the first active material layer of one cell and the second active material layer of a cell adjacent to the one cell. The edge insulating device is formed of the solid electrolyte material, encloses the first active material layer peripheral edge and is contiguous with the solid electrolyte layer.

In some embodiments, the edge insulating device is configured to electrically insulate portions of a given cell of the stacked arrangement from portions of an adjacent cell of the stacked arrangement.

In some aspects, the arrangement in which each cell is enclosed in a gas-impermeable housing is replaced by several single, housing-free electrochemical cells that are stacked so that each cell forms a direct series connection with an adjacent cell of the cell stack. Each cell has a planar shape, and includes a nearly equal sized planar anode and planar cathode that are provided by a corresponding active material layer. The anode and cathode are separated by a solid electrolyte layer (e.g., the anode and cathode are not wound as coil or folded in a z-fold configuration). In addition, each cell has bipolar plate between the cathode of one cell and the connected anode of an adjacent cell. In the cell stack, each cathode in the series arrangement is electrically connected to the next anode directly without an intervening housing. The bipolar plate replaces the cathodic and anodic current collector, and also prevents a chemical reaction between the anode active material and the cathode active material. In case of lithium ion cells, the bipolar plate may include, for example, a copper foil on one side thereof that provides the anode, and an aluminum foil on an opposed side thereof that provides the cathode. The foils may be adjoining, or may provide the outermost layers of an intervening electrically conductive substrate.

In some embodiments, each electrochemical cell may have a coverage of about 3 mAh/cm² and a lithium metal anode. Upon cell charging, the lithium metal anode expands in a direction perpendicular to the layers, for example about 13-15 micrometers (μm), by generating a deposited lithium metal layer on the anode. The cell hence “breathes” (e.g., expands and contracts) between charging and discharging by about 13-15 μm.

The cells, when connected in series, are arranged having their active material layers along with the bipolar plate quite close together. For example, the spacing of the layers may correspond to just the dimension of the cell thickness, which may be only between 40 μm to 120 μm. The bipolar plates of one cell of the cell stack and the adjacent cell are also similarly spaced. The cell includes a structure that provides cell peripheral edge insulation and still allows the cells of the cell stack to expand and contract without the device, or the cell itself, being broken.

The cell stack has a series electrical connection between adjacent bipolar cells of the cell stack, and each cell of the cell stack includes a solid electrolyte layer. The solid electrolyte layer includes a separating portion disposed between the active material layers and an edge insulating portion that is contiguous with, and surrounds, the separating portion. In some embodiments, the edge insulating portion is placed onto, and encapsulates, the first active material layer, e.g., the cell cathode. In some embodiments, the edge insulating portion is assembled with the cell mechanically by placing it onto the cathode. In some embodiments, the edge insulating portion is secured to only the bipolar plate of a given cell for example using adhesive, and is unsecured with respect to the adjacent cell. By being secured only to the given cell and not to the adjacent cell, each cell, and the cell stack as a whole, is permitted to expand and contract during charge cycling. In addition, a situation is avoided in which the edge insulating portion and/or the cell itself tears apart upon cell expansion and contraction, which could occur if the edge insulating portion were to be fixed to both cells of an adjacent pair of cells.

The details of one or more features, aspects, implementations, and advantages of this disclosure are set forth in the accompanying drawings, the detailed description, and the claims below.

### BRIEF DESCRIPTION OF THE DRAWINGS

FIG. 1 is a schematic cross-sectional view of a battery including battery housing and a cell stack disposed in the battery housing.

FIG. 2 is a cross-sectional view of a peripheral portion of the cell stack of FIG. 1.

FIG. 2a is an enlargement of the portion of the cell identified in FIG. 2 by broken lines.

FIG. 3 is a schematic view of the cell stack of FIG. 1 as seen along line 3-3 of FIG. 2.

FIG. 4 is a cross-sectional view of a peripheral portion of an alternative embodiment cell stack.

FIG. 5 is a schematic view of the cell stack of FIG. 4 as seen along line 5-5 of FIG. 4.

FIG. 6 is a cross-sectional view of a peripheral portion of another alternative embodiment cell stack.

### DETAILED DESCRIPTION

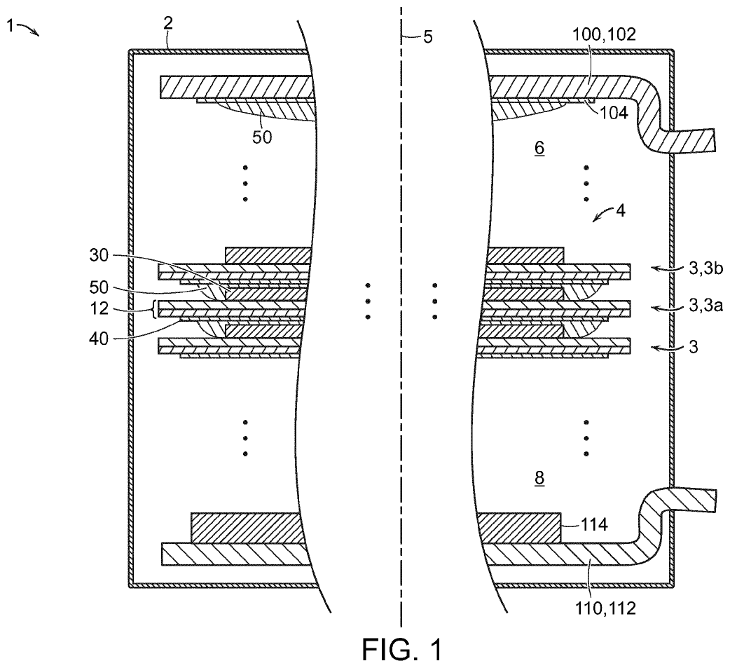

Referring to FIG. 1, a battery 1 is a power generation and storage device that includes a battery housing 2 that encloses a stacked arrangement of electrochemical cells 3. The battery housing 2 is configured so that air, moisture and/or other contaminants are prevented from entering the interior space that contains the cells 3. For example, in some embodiments, the battery housing 2 is formed of a flexible laminate material that includes a metal foil that is sandwiched between polymer layers, and that is provided in the form of a sealed pouch.

The cells 3 may be lithium-ion secondary cells, but are not limited to a lithium-ion cell chemistry. The cells 3 are free of a cell housing, have a generally planar, low-profile shape and are stacked along a stack axis 5 so that each cell 3a forms a direct series connection with an adjacent cell 3b of the cell stack 4. Each cell 3 includes a bipolar plate 12 having active material layers 30, 40 provided on opposed surfaces thereof, and a solid electrolyte layer 50 that permits ion exchange between adjacent cells 3a, 3b while preventing electrical contact between the active material layers 30, 40 of adjacent cells 3a, 3b. In FIG. 1 and in other figures, due to the thinness of the material layers that constitute the cells 3, the constituents of the cells 3 are shown schematically and are not to scale.

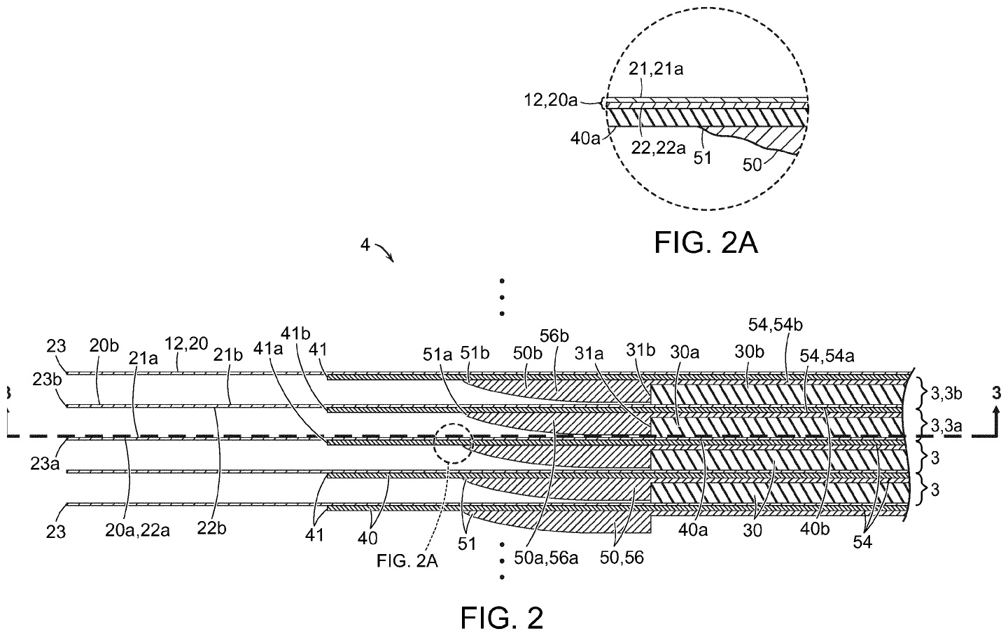

Referring to FIGS. 2 and 2A, a portion of a periphery of the cell stack 4 is shown. In this figure and other figures, only four complete cells 3 of the cell stack 4 are shown, and ellipses above and/or below the illustrated cells 3 are used to indicate additional cells reside on one or both sides of the illustrated cells. The bipolar plate 12 includes a plate-like substrate 20, a first active material layer 30 that is formed on a first surface 21 of the substrate 20 and provides a cathode, and a second active material layer 40 that is formed on a second, opposed surface 22 of the substrate 20 and provides an anode.

The substrate 20 is an electrical conductor and an ion insulator, and may be a clad plate that has a first metal foil on one side thereof that provides the first surface 21, and second metal foil on an opposed side thereof that provides the second surface 22 (shown in FIG. 2A). When the cell 3 employs lithium ion cell chemistry, the substrate 20 may include, for example, an aluminum foil on one side that provides the cathode substrate, and a copper foil on the opposed side that provides the anode substrate. In some embodiments, the foils may be adjoining. For example, the substrate 20 can be realized by providing a copper foil and having aluminum evaporated or plated on one side, or alternatively, by providing an aluminum foil and having copper evaporated or plated on one side. In other embodiments, the substrate 20 may be a clad plate that is formed of other pairs of electrically conductive materials and/or formed via other appropriate techniques.

In still other embodiments, the substrate 20 may include metal foils that form the opposed, outermost layers of an intervening electrically conductive substrate.

In still other embodiments, the substrate 20 may be a solid (e.g., non-clad and formed of a single material) plate that is formed of an electrically conductive material. For example, in some embodiments, the substrate 20 may be a solid nickel foil or a solid stainless steel foil.

The first active material layer 30 is formed on the substrate first surface 21. The first active material layer 30 is formed of an active material. As used herein, the term “active material” refers to an electrochemically active material within the cell that participates in the electrochemical reactions of charge or discharge. The first active material layer 30 has a first active material layer peripheral edge 31 that is spaced apart from, and disposed closer to a center 24 of the substrate 20 than, a peripheral edge 23 of the substrate 20. In embodiments where the first surface 21 is formed of aluminum, the first active material layer 30 may be formed of, for example, a lithiated metal oxide, where the metal portion of the lithiated metal oxide can be cobalt, manganese, nickel, or a complex of the three.

The second active material layer 40 is formed on the substrate second surface 22. The second active material layer 40 is formed of a different active material than the active material used to form the first active material layer 30. The second active material layer 40 has a second active material layer peripheral edge 41 that is spaced apart from the substrate peripheral edge 23. In particular, the second active material layer peripheral edge 41 is not aligned with the first active material layer peripheral edge 31 along an axis parallel to the stack axis 5 in order to avoid edge effects and current concentration at the edge of the anode. To this end, the second active material layer peripheral edge 41 is disposed closer to a center 24 of the substrate 20 than the substrate peripheral edge 23, and is disposed between the substrate peripheral edge 23 and the first active material layer peripheral edge 31. In embodiments where the second surface 22 is formed of copper, the second active material layer 40 may be formed of, for example, lithium metal.

The solid electrolyte layer 50 is formed of a solid electrolyte, e.g., a solid material that is ionically conductive and electrically insulative, and may be provided as a film. The solid electrolyte layer 50 includes a separating portion 54 and an edge insulating portion 56 that is contiguous with the periphery of the separating portion 54. The separating portion 54 is the portion of the solid electrolyte material layer 50 that is disposed between, and facilitates ion conduction between, the first active material layer 30 (e.g. first active material layer 30a) of a given cell 3a and the second active material layer 40 (e.g. second active material layer 40b) of an adjacent cell 3b in the cell stacking direction (e.g., in a direction parallel to the stack axis 5).

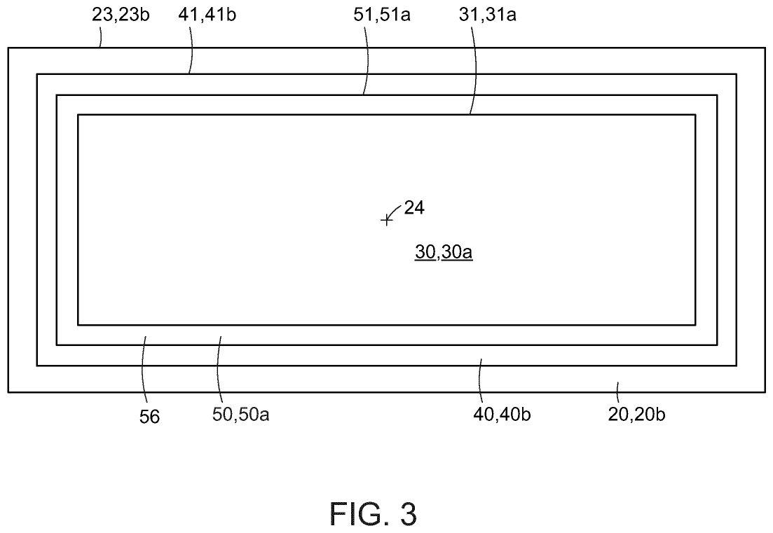

The edge insulating portion 56 is the portion of the solid electrolyte material layer 50 that is disposed laterally outward of (further from the center 24 of the substrate 20 than) the first active material layer 30 and includes the solid electrolyte layer peripheral edge 51. The edge insulating portion 56 surrounds the separating portion 54 and thus has the shape of a frame when viewed in a direction parallel to the stack axis 5 (FIG. 3). In the cell stacking direction, the edge insulating portion 56 resides between the first surface 21 of a given cell 3a and the second active material layer 40, 4b of an adjacent cell 3b. The edge insulating portion 56 is relatively more thick than the separating portion 54. However, regardless of the charge state of the cells 3, the edge insulating portion 56 has a thickness that is less than a sum of the thicknesses of the first active material layer 30, the separating portion 54 and the second active material layer 40, where the thickness corresponds to a dimension in a direction parallel to the stack axis 5.

The separating portion 54 and the edge insulating portion 56 cooperate to encapsulate the first active material layer 30. In particular, the solid electrolyte layer 50 encloses the first active material layer 30 including the peripheral edge 31, and a peripheral edge 51 of the solid electrolyte layer 50 is further from the center 24 of the substrate 20 than the first active material layer peripheral edge 31 and closer to the center of the substrate 20 than the second active material layer peripheral edge 41. As a result, the solid electrolyte layer 50 is configured to prevent the first active material layer 30 from coming into contact with air and moisture, and to act as the ionic conductor between the first active material layer 30 of a given cell 3a and the second active material layer 40 of the adjacent cell 3b. In addition, due to its electrically insulative properties, the solid electrolyte layer 50 prevents an electrical short circuit between the substrates 20a, 20b of adjacent cells 3a, 3b. Other than the solid electrolyte layer 50, the stacked arrangement of electrochemical cells is free of an electrically insulating structure between each pair of adjacent bipolar plates.

In the illustrated embodiment, the solid electrolyte layer 50 (i.e., the solid electrolyte layer 50a that is disposed between substrates 20a, 20b of adjacent cells 3a, 3b) including the separating portion 54 and the edge insulating portion 56, is disposed on, and secured to, the first active material layer 30a of the cell 3a. Thus, the solid electrolyte layer 50a is secured indirectly to the first surface 21a of the substrate 20a of the bipolar plate 12a of one cell 3a via the first active material layer 30a, for example using an adhesive or other appropriate methods. On the other hand, the solid electrolyte layer 50a, although in contact with the second active material layer 40b of the adjacent cell 3b, is not secured to the second active material layer 40b of the adjacent cell 3b. Since it is secured to only one cell 3a of the pair of adjacent cells 3a, 3b, the solid electrolyte layer 50a can accommodate cell expansion and contraction due to charge cycling without damaging itself or the adjacent cells 3a, 3b.

In other embodiments, the solid electrolyte layer 50a including the separating portion 54 and the edge insulating portion 56, is disposed on, and secured to, the second active material layer 40b of the adjacent cell 3b. Thus, the solid electrolyte layer 50a is secured indirectly to the substrate second surface 22b the adjacent cell 3b via the second active material layer 40b, for example using an adhesive or other appropriate methods. On the other hand, the solid electrolyte layer 50b, although in contact with the first active material layer 30a of the cell 3a, is not secured to the first active material layer 30a of the cell 3a. Since it is secured to only one cell 3b of the pair of adjacent cells 3a, 3b, the solid electrolyte layer 50a can accommodate cell expansion and contraction due to charge cycling without damaging itself or the adjacent cells 3a, 3b.

The solid electrolyte layer 50 includes the edge insulating portion 56 having a length (e.g., a dimension in a direction transverse to the stack axis 5 and parallel to the first surface 21) that is sufficiently large to prevent the bipolar plate substrates 20a, 20b of adjacent cells 3a, 3b from contacting each other and forming an electrical short circuit. In some embodiments, the length of the edge insulating portion 56 may be 3 to 20 times the cell thickness.

In some embodiments, the solid electrolyte layer 50, including both the separating portion 54 and the edge insulating portion 56, may be formed, for example, of a solid polymer electrolyte that includes a polymer similar to the polymer used to form the active material layers 30, 40, a salt identical to the salt used to form the active material layers 30, 40, and an additive such as is sold under the name DryLyte™ by Seeo, Incorporated of Hayward, Calif. In other embodiments, the solid polymer electrolyte layer 50 may be formed of other materials, including ceramics or a mix of ceramic and polymer materials.

In still other embodiments, the separating portion 54 may be formed of a substrate material that includes ionically conductive salt, and the edge insulating portion 56 may be formed of the same substrate material and is free of the ionically conductive salt.

In still other embodiments, the solid polymer layer 50 may be formed of a ceramic, a composite of a ceramic and a polymer, or other material that is appropriate for the particular application.

Referring again to FIG. 1, the battery 1 includes a negative end terminal 100 disposed at one end (e.g., a first end 6) of the cell stack 4 that is electrically connected to the outermost cell 3 at the first end 6 of the cell stack 4. In addition, the battery 1 includes a positive end terminal 110 disposed at the opposed end (e.g., second end 8) of the cell stack 4. The positive end terminal 110 is electrically connected to the outermost cell 3 at the second end 8 of the cell stack 4.

The negative end terminal 100 includes an electrically conductive sheet (for example, a copper sheet) that serves as a negative current collector 102, and a negative current collector active material layer 104 formed on the cell stack-facing surface of the negative current collector 102. The negative current collector active material layer 104 employs that same active material layer used to form the anodes of the cell 3. In the illustrated embodiment directed to a lithium-ion cell chemistry, the negative current collector active material layer 104 may be, for example, lithium metal that is coated in solid electrolyte material. In use, the negative end terminal 100 is stacked onto the first end 6 of the cell stack 4 so that the negative current collector active material layer 104 is in direct contact with, and forms an electrical connection with, the first active material layer 30 of the outermost cell of the first end 6 of the cell stack 4.

The positive end terminal 110 includes an electrically conductive sheet (for example, an aluminum sheet) that serves as a positive current collector 112, and a positive current collector active material layer 114 formed on the cell stack-facing surface of the positive current collector 112. The positive current collector active material layer 114 employs that same active material layer used to form the cathodes of the cell 3. In the illustrated embodiment directed to a lithium-ion cell chemistry, the positive current collector active material layer 114 may be, for example, a lithiated metal oxide. In use, the positive end terminal 110 is stacked onto the second end 8 of the cell stack 4 so that the positive current collector active material layer 114 contacts a solid electrolyte layer 50 and via the solid electrolyte layer 50 forms an electrical connection with, the second active material layer 40 of the outermost cell 3 of the second end of the cell stack 4.

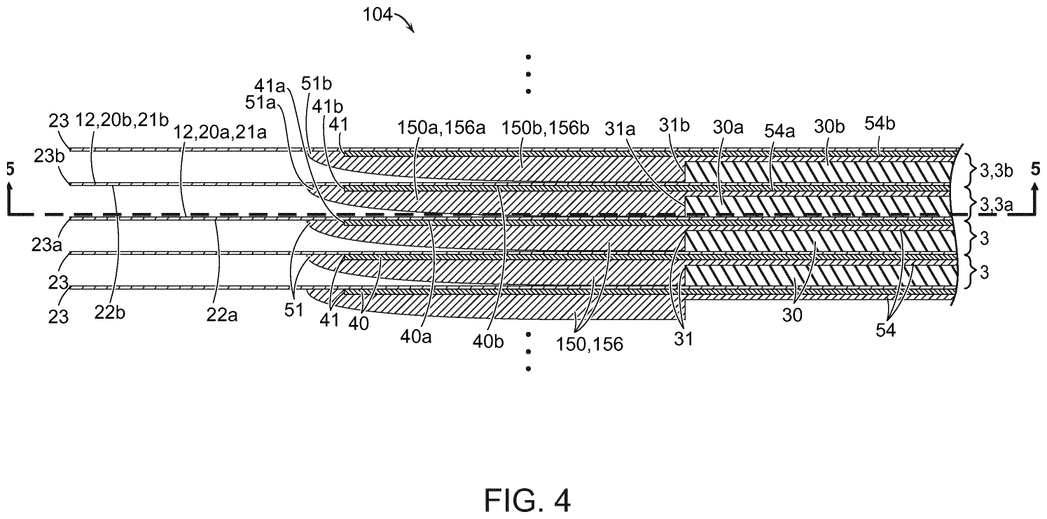

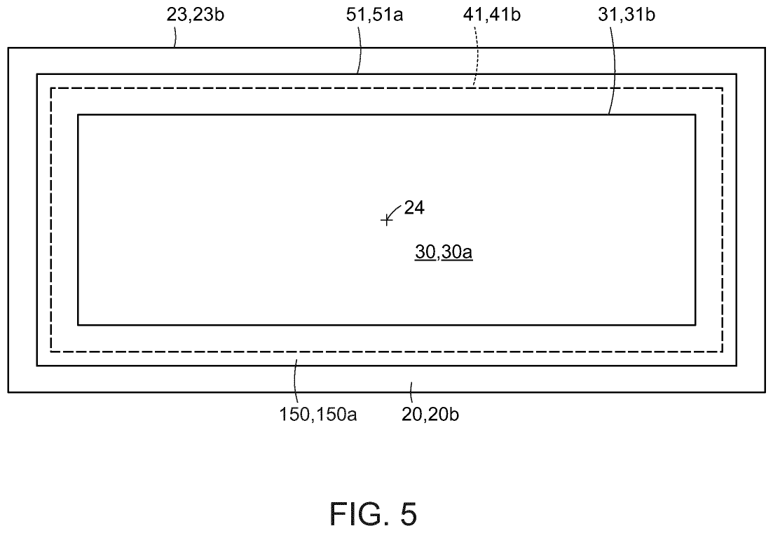

Referring to FIGS. 4 and 5, an alternative embodiment cell stack 104 is similar to the cell stack 4 described above with respect to FIGS. 2 and 3, and common reference numbers are used to refer to common elements. The alternative embodiment cell stack 104 of FIGS. 4 and 5 differs from the cell stack 4 described above with respect to FIGS. 2 and 3, with respect to the configuration of the solid electrolyte layer 150. Like the previous embodiment, the solid electrolyte layer 150 includes the separating portion 54 and an edge insulating portion 156. In the cell stack 104, the edge insulating portion 156 has a length that is greater than the length of the edge insulating portion 56 shown in FIG. 2. In particular, the edge insulating portion 156 of FIGS. 4 and 5 has a length such that the peripheral edge 51 of the solid electrolyte layer 150 is further from the center 24 of the substrate 20 than both the first active material layer peripheral edge 31 and the second active material layer peripheral edge 41. As a result, the solid electrolyte layer 150 is configured to prevent the first active material layer 30 and the second active material layer 40 from coming into contact with air and moisture, and to act as the ionic conductor between the first active material layer 30 of one cell 3a and the second active material layer 40 of the adjacent cell 3b. In addition, due to its electrically insulative properties, the solid electrolyte layer 150 prevents an electrical short circuit between the substrates 20a, 20b of adjacent cells 3a, 3b. Other than the solid electrolyte layer 150, the stacked arrangement of electrochemical cells is free of an electrically insulating structure between each pair of adjacent bipolar plates.

In some embodiments, the solid electrolyte layer 150a (i.e., the solid electrolyte layer 150 that is disposed between substrates 20a, 20b of adjacent cells 3a, 3b) including the separating portion 54 and the edge insulating portion 156, is disposed on, and secured to, the first active material layer 30a of the cell 3a. Thus, the solid electrolyte layer 150a is secured indirectly to the substrate first surface 21a of the bipolar plate 12a of one cell 3a via the first active material layer 30a, for example using an adhesive or other appropriate methods. On the other hand, the solid electrolyte layer 150a, although in contact with the second active material layer 40b of the adjacent cell 3b and the substrate second surface 22b, is not secured to the second active material layer 40b or the substrate second surface 22b the adjacent cell 3b. Since it is secured to only one cell 3a of the pair of adjacent cells 3a, 3b, the solid electrolyte layer 150a can accommodate cell expansion and contraction due to charge cycling without damaging itself or the adjacent cells 3a, 3b.

In other embodiments, the solid electrolyte layer 150a (i.e., the solid electrolyte layer 150 that is disposed between substrates 20a, 20b of adjacent cells 3a, 3b) including the separating portion 54 and the edge insulating portion 156, is disposed on, and secured to, the second active material layer 40b of the adjacent cell 3b and the substrate second surface 22b of the adjacent cell 3b. Thus, the solid electrolyte layer 150a is secured directly and indirectly to the substrate second surface 22b the adjacent cell 3b, for example using an adhesive or other appropriate methods. On the other hand, the solid electrolyte layer 150a, although in contact with the first active material layer 30a of the cell 3a, is not secured to the first active material layer 30a of the cell 3a. Since it is secured to only one cell 3b of the pair of adjacent cells 3a, 3b, the solid electrolyte layer 150a can accommodate cell expansion and contraction due to charge cycling without damaging itself or the adjacent cells 3a, 3b.

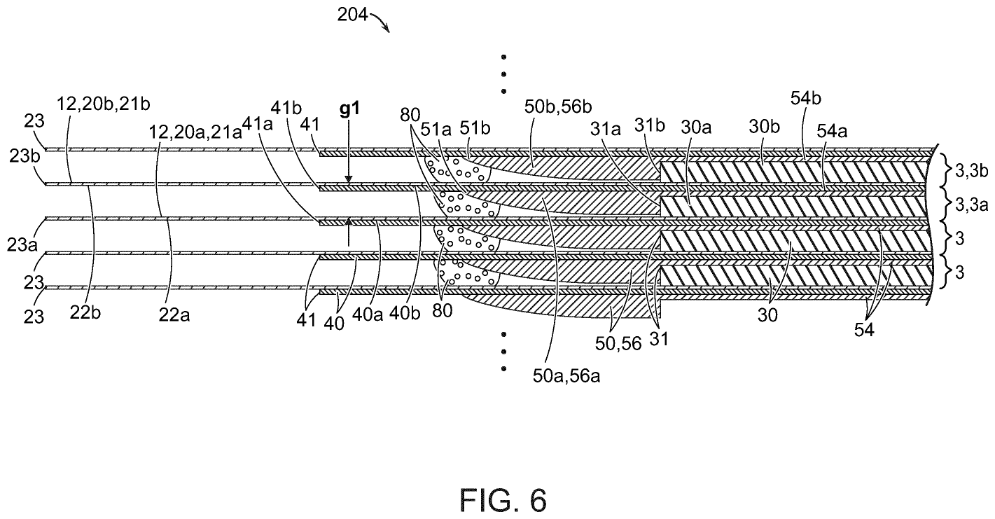

Referring to FIG. 6, as previously discussed, solid electrolyte layer 50 physically contacts, and is directly secured to, either the first active material layer 30 of one cell (e.g., cell 3a) or the second active material layer 40 of an adjacent cell (e.g., cell 3b), while not being secured to other of the first active material layer 30 of the one cell 3a and the second active material layer 40 of the adjacent cell 3b. Since the solid electrolyte layer 50 is not fixed to both the first active material layer 30 of the one cell 3a and the second active material layer 40 of the adjacent cell 3b, it is possible for air or moisture to enter the cell 3 between the solid electrolyte layer 50 and the first active material layer 30 of the one cell 3a or the second active material layer 40 of the adjacent cell 3b. For this reason, in some embodiments, each cell includes an elastic seal device 80. The seal device 80 provides a moisture impermeable seal about a periphery of the cell 3, and is disposed in the gap g1 between the substrate first surface 21a of one cell 3a and the second active material layer 40b of the adjacent cell 3b. More specifically, the seal device 80 is disposed between, directly physically contacts, and forms a seal with the substrate first surface 21a of one cell 3a and the second active material layer 40b of the adjacent cell 3b. In some embodiments, the seal device 80 may be positioned so as to also form a seal with the solid electrolyte layer peripheral edge 51. As a result, the seal device 80 provides a bather that prevents moisture and other contaminants from contacting the solid electrolyte layer 50 and the electrochemically active materials. In addition, due to the elasticity of the seal device 80 and since the seal device 80 adjoins the solid electrolyte layer peripheral edge 51, the seal device 80 may apply an outward force that compresses the peripheral edge 51 and serves to prevent the electrolyte layer 50b from peeling away from its substrate 20b.

The seal device 80 provides impermeability by closing the gap g1. The seal device 80 may be provided, for example, in the form of a strip of an elastic material, or in the form of a closed pore elastic foam or polymer that is printed or glued on the substrate first surface 21. The seal device 80 may extend about the circumference of the cell 3, whereby the seal device 80 may have the shape of a frame when viewed in a direction parallel to a stacking direction of the cells 3.

The seal device 80 has elastic properties that allow it to compensate for cell dimensional changes in a direction parallel to the stack axis 5 including the expansion and contraction associated with charge cycling. Since the amount of expansion or contraction can correspond to up to 10 percent or more of cell thickness, the seal device 80 must be sufficiently elastic to maintain the seal despite the cell dimensional changes.

In addition to being sufficiently elastic to accommodate cell expansion and contraction due to charge cycling, the material used to form the seal device 80 must also be impervious to moisture. In some embodiments, the seal device 80 may be a closed-pore elastic foam rubber in which the pore fraction of the closed pore elastic foam is sufficient to compensate for an expansion and contraction of the cell 3 of up to 10 percent or more of cell thickness. In other embodiments, the seal device 80 may be formed of other materials that address the requirements of the specific application, including, but not limited to, an open-cell foam rubber.

Although the battery housing 2 may be formed of a flexible laminate material that is provided in the form of a sealed pouch, the battery housing is not limited to this configuration. For example, in other embodiments, the battery housing 2 may be a prismatic (e.g., rectangular) housing formed of a rigid material.

The embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling with the sprit and scope of this disclosure.

We claim:

1. A battery comprising a stacked arrangement of electrochemical cells, each electrochemical cell comprising
a bipolar plate that includes a substrate, a first active material layer formed on a first surface of the substrate, and a second active material layer formed on a second surface of the substrate, the second surface being opposed to the first surface, the first active material layer having a first active material layer peripheral edge that is spaced apart from, and disposed closer to a center of the substrate than, a substrate peripheral edge, the second active material layer being formed of a different material than the material used to form the first active material layer, the second active material layer having a second active material layer peripheral edge that is spaced apart from the substrate peripheral edge, and
a solid electrolyte layer that is ionically conductive and electrically insulative, the solid electrolyte layer including a separating portion and an edge insulating portion that is contiguous with the separating portion, wherein
the separating portion is disposed between, and facilitates ion conduction between, the first active material layer of a given cell and the second active material layer of an adjacent cell in the cell stacking direction,
the edge insulating portion is disposed between the first surface of the given cell and the second active material layer of the adjacent cell in the cell stacking direction, the separating portion and the edge insulating portion cooperate to encapsulate the first active material layer.

2. The battery of claim 1, wherein, other than the solid electrolyte layer, the stacked arrangement of electrochemical cells is free of an electrically insulating structure between each pair of adjacent bipolar plates.

3. The battery of claim 1, wherein the edge insulating portion is disposed further from the center of the substrate than the separating portion, and the edge insulating portion surrounds a periphery of the separating portion.

4. The battery of claim 1, wherein regardless of the charge state of the cells, the edge insulating portion has a thickness that is greater than the thickness of the separating portion and that is less than a sum of the thicknesses of the first active material layer, the separating portion and the second active material layer, where the thickness corresponds to a dimension in a direction parallel to a stacking direction of the cells.

5. The battery of claim 1, wherein the separating portion is formed of a material and includes ionically conductive salt, and the edge insulating portion is formed of the material and is free of ionically conductive salt.

6. The battery of claim 1 wherein the first active material layer peripheral edge is disposed closer to the center of the substrate than both the substrate peripheral edge and the second active material layer peripheral edge.

7. The battery of claim 1, wherein a peripheral edge of the solid electrolyte layer is closer to the center of the substrate than the second active material layer peripheral edge, and the peripheral edge of the solid electrolyte layer is further from the center of the substrate than the first active material layer peripheral edge.

8. The battery of claim 1, wherein a peripheral edge of the solid electrolyte layer is further the center of the substrate than the second active material layer peripheral edge and the first active material layer peripheral edge.

9. The battery of claim 1, wherein the edge insulating portion is secured to the first surface.

10. The battery of claim 1, wherein the edge insulating portion surrounds the separating portion and has the shape of a frame when viewed in a direction parallel to a stacking direction of the cells.

11. The battery of claim 1, comprising a battery housing that encloses the stacked arrangement of cells, the battery housing configured to prevent contaminants from entering an interior space of the battery housing.

12. The battery of claim 11, wherein the battery housing is formed of a flexible material that is a laminate of a metal foil that is sandwiched between polymer layers.

13. The battery of claim 1, wherein the first active material layer cooperates with the first surface to provide a cell cathode, and the second active material layer cooperates with the second surface to provide a cell anode.

14. The battery of claim 1, wherein the solid electrolyte layer is formed of a polymer.

15. The battery of claim 1, wherein the solid electrolyte layer is formed of a ceramic.

16. The battery of claim 1, wherein the solid electrolyte layer is formed of composite of a polymer and a ceramic.

17. The battery of claim 1, wherein the solid electrolyte layer is secured to the given cell and free to move relative to the adjacent cell, or is secured to the adjacent cell and is free to move relative to the given cell.

18. A battery comprising a stacked arrangement of electrochemical cells, each electrochemical cell comprising
a bipolar plate that includes a substrate, a first active material layer formed on a first surface of the substrate, and a second active material layer formed on a second surface of the substrate, the second surface being opposed to the first surface, the first active material layer having a first active material layer peripheral edge that is spaced apart from, and disposed closer to a center of the substrate than, a substrate peripheral edge, the second active material layer being formed of a different material than the material used to form the first active material layer, the second active material layer having a second active material layer peripheral edge that is spaced apart from the substrate peripheral edge,
a solid electrolyte layer that is formed of a solid electrolyte material and is disposed between the first active material layer of one cell and the second active material layer of a cell adjacent to the one cell, and
an edge insulating device formed of the solid electrolyte material that encloses the first active material layer peripheral edge and is contiguous with the solid electrolyte layer.

19. The battery of claim 18, wherein the edge insulating device is configured to electrically insulate portions of a given cell of the stacked arrangement from portions of an adjacent cell of the stacked arrangement.
